(19) United States
(12) Patent Application Publication
(10) Pub. No.: US 2011/0321110 A1
(43) Pub. Date: Dec. 29, 2011

(54) SYSTEMS AND METHODS FOR ADAPTING VIDEO DATA TRANSMISSIONS TO COMMUNICATION NETWORK BANDWIDTH VARIATIONS

(75) Inventor: Olivier Aubin, Calgary (CA)

(73) Assignee: Worldplay (Barbados) Inc., Bridgetown (BB)

(21) Appl. No.: 12/822,899

(22) Filed: Jun. 24, 2010

(51) Int. Cl. H04N 7/173

(52) U.S. Cl. 725/116

(57) ABSTRACT

Systems and methods are described for modifying the hint track to smooth out the data transmission rates thereby reducing bandwidth spikes during transmission. In one embodiment, this is accomplished by examining the size of each frame and using the frame rate to calculate per-frame bitrates. The transmission start times are then adjusted for each packet in order to spread out packet transmission times and (if necessary) lengthen frame transmission times. This has the effect of reducing the bandwidth peaks. In effect, every network packet is planned in advance and a detailed description of what data should be sent at what point in time is stored in the hint tracks. Thus, the streaming server simply looks up the correct data send timing in a table, rather than performing expensive calculations repeatedly at send time.

### CROSS-REFERENCE TO RELATED APPLICATIONS

This application is related to commonly owned patent application SYSTEMS AND METHODS FOR HIGHLY EFFICIENT VIDEO COMPRESSION USING SELECTIVE RETENTION OF RELEVANT VISUAL DETAIL, U.S. patent application Ser. No. 12/176,374, filed on Jul. 19, 2008, Attorney Docket No. 54729/P012US/10808779; SYSTEMS AND METHODS FOR DEBLOCKING SEQUENTIAL IMAGES BY DETERMINING PIXEL INTENSITIES BASED ON LOCAL STATISTICAL MEASURES, U.S. patent application Ser. No. 12/333,708, filed on Dec. 12, 2008, Attorney Docket No. 54729/P013US/10808780; VIDEO DECODER, U.S. patent application Ser. No. 12/638,703, filed on Dec. 15, 2009, Attorney Docket No. 54729/P015US/11000742 and concurrently filed, co-pending, commonly owned patent applications SYSTEMS AND METHODS FOR HIGHLY EFFICIENT COMPRESSION OF VIDEO, U.S. patent application Ser. No. ______, Attorney Docket No. 54729/P016US/11000746; A METHOD FOR DOWNSAMPLING IMAGES, U.S. patent application Ser. No. ______, Attorney Docket No. 54729/P017US/11000747; DECODER FOR MULTIPLE INDEPENDENT VIDEO STREAM DECODING, U.S. patent application Ser. No. ______, Attorney Docket No. 54729/P018US/11000748; SYSTEMS AND METHODS FOR CONTROLLING THE TRANSMISSION OF INDEPENDENT BUT TEMPORALLY RELATED ELEMENTARY VIDEO STREAMS, U.S. patent application Ser. No. ______, Attorney Docket No. 54729/P019US/11000749; and SYSTEM AND METHOD FOR MASS DISTRIBUTION OF HIGH QUALITY VIDEO, U.S. patent application Ser. No. ______, Attorney Docket No. 54729/P021US/11000751 all of the above-referenced applications are hereby incorporated by reference herein.

### TECHNICAL FIELD

This disclosure relates to video data transmission and more particularly to systems and methods for adapting video data transmissions to communication network bandwidth variations.

### BACKGROUND OF THE INVENTION

When streaming video data across a network, a presentation delay typically occurs whenever the data rate required for a given video segment exceeds the available network bandwidth. Whenever it is desirable to avoid such delays, video data is typical buffered to some degree. The scope of such buffering can range from downloading the entire video in advance, to sending only a limited subset at a time. Sending the entire video in advance is a non-streaming scenario that results in maximum up-front delay. Sending only limited amounts ahead causing a more modest, but often insufficient, up-front delay.

It is often required that a selected video begins playing at the receiving end within a reasonable time frame from when it begins downloading and thus normally precludes downloading the entire file. Deciding on an optimal video buffer size can be challenging, either in terms of choosing a proper data size or in determining the number of seconds of playback time to allow in the buffer.

Typically, streaming servers are set to use minimal buffers based on the assumption that the network bandwidth is sufficient to handle the variability that is most often associated with video data. Whenever such a minimal buffer runs out of data while a local video data peak exceeds the available network bandwidth, an undesirable presentation delay (video viewing interruption) results. Thus, the system designer is caught between two undesirable option, i.e., setting the buffer limits too low (which results in playback interruptions) or setting the buffer limits too high results in unnecessarily long up-front delays, which in the worst case, tends towards the maximum delay characteristic of the full video download scenario.

It is difficult to match bitrate (file size divided by video length) to network bandwidth capacity. In practice, the bitrate varies throughout the video, meaning there are peaks where more bandwidth is required than is available. Existing video servers simply send each video frame at its display time, assuming that the frame will be delivered by a network with bandwidth exceeding the video's maximum instantaneous frame rate. This, as discussed above, leads to pauses in the viewed video while the limited bandwidth network pushes through all the required data for the next frame. The goal is to ensure that all video data is available at, or prior to, the time needed for viewing.

One attempt to handle transmission is found in MPEG4 files which are used in network streaming. These files contain supplemental metadata tracks known as hint tracks which describe the detailed layout of the video data within the file, together with information about when those pieces of data should be sent out on the network. The hinter schedules data for transmission based on what data needs to be sent together. Thus, at the beginning of a frame the hinter might say “send all the data for this frame at once”. This then results in a very spiky network bandwidth profile.

### BRIEF SUMMARY OF THE INVENTION

Systems and methods are described for modifying the hint track to smooth out the data transmission rates thereby reducing bandwidth spikes during transmission. In one embodiment, this is accomplished by examining the size of each frame and using the frame rate to calculate per-frame bitrates. The transmission start times are then adjusted for each packet in order to spread out packet transmission times and (if necessary) lengthen frame transmission times. This has the effect of reducing the bandwidth peaks. In effect, every network packet is planned in advance and a detailed description of what data should be sent at what point in time is stored in the hint tracks. Thus, the streaming server simply looks up the correct data send timing in a table, rather than performing expensive calculations repeatedly at send time.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 depicts one embodiment of data structures used to facilitate the rehinting process according to the concepts of this invention; and

FIG. 2 shows one embodiment of a process for achieving proper rehinting.

### DETAILED DESCRIPTION OF THE INVENTION

It is helpful to think of the varying bitrates of video transmission frames as a sequence of peaks and valleys over time with the peaks containing more data bits than do the valleys. When more data arrives than the network can handle at a given instant of time (a peak) the communication network will operate to delay the data which is in excess of the bandwidth until less data (a valley) arrives. The delayed peak data will be transmitted past the bandwidth limitation during the next valley in order to catch up. In operation, the peak appears to fill the valley, however, the bit order is preserved. Specifically, the bits forming the peak are transmitted prior to the bits from the valley. For smooth viewing of the video it is desirable that all data is available at, or prior to, the time required for viewing that data. As will be discussed, this can be achieved by moving the peaks forward (instead of back) to fill valleys ahead of the peak.

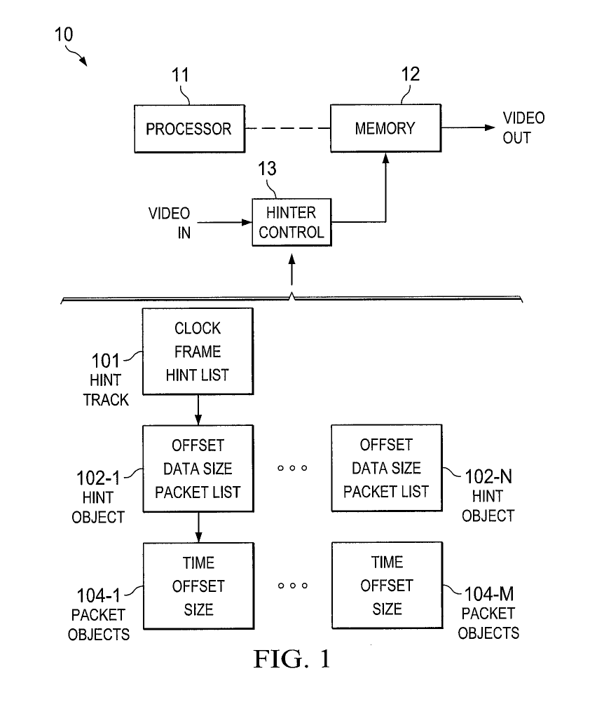

FIG. 1 depicts one embodiment 10 of a hinter, including example data structures 101,102, 104 used to facilitate the rehinting process. These data structures closely mirror the structure of a hint track, but show only the subset of hint information required to calculate stream bitrates and modify the send times of packets. The video frames of the file, such as a movie, are received by hinter control 13 under control of a processor, such as processor 11. The output of the hinter control 13 can be stored temporarily or for periods of time in memory 12 before being sent to the network for delivery to a remote location. The output of memory 12 will be compressed, for example, as discussed in the above-identified patent application titled SYSTEMS AND METHODS FOR HIGHLY EFFICIENT COMPRESSION OF VIDEO.

Block 101 depicts the top level data structure object representing the entire hint track. For discussion purposes herein we care about the clock, the frame and the hint list. The clock is the MPEG4 timescale for this video track, measured in ticks per second. The frame is the number of clock ticks in a single frame of video, and the hint list is a list of hint objects, one for each frame of video.

Blocks 102-1 to 102-N depict a linked list of N hint objects, one for each of the N frames of video in the file being transmitted. Typically, the file would be, for example, a single movie. For the purposes of this discussion we care about the offset, the data size, and the packet list. The offset is the location in the data file where this hint object is stored. The data size is the number of data bytes which will eventually be sent for this frame of video, including things like video data and any additional network headers required by the streaming protocol. The data size keeps track of the amount of data (peaks or valleys) that needs to me transmitted on a frame by frame (or any other convenient marker) basis. The packet list is a list of descriptors indicating how the data for this frame of video will be packetized for transmission over the network.

Blocks 104-1 to 104-M depict a linked list of M packet objects, one for each of the M network packets which will be used to transmit this particular frame of video. For the purposes of this discussion we care about the time, the offset and the size. The time is the send time in clock ticks of this network packet. The offset is the location in the data file where this packet structure is stored relative to the hint offset in block 102. The offset is used to determine the time value in the file so that it can be modified appropriately based upon the peaks and valleys ahead of it. The size indicates the amount of data (for example, in bytes) transferred by this packet descriptor.

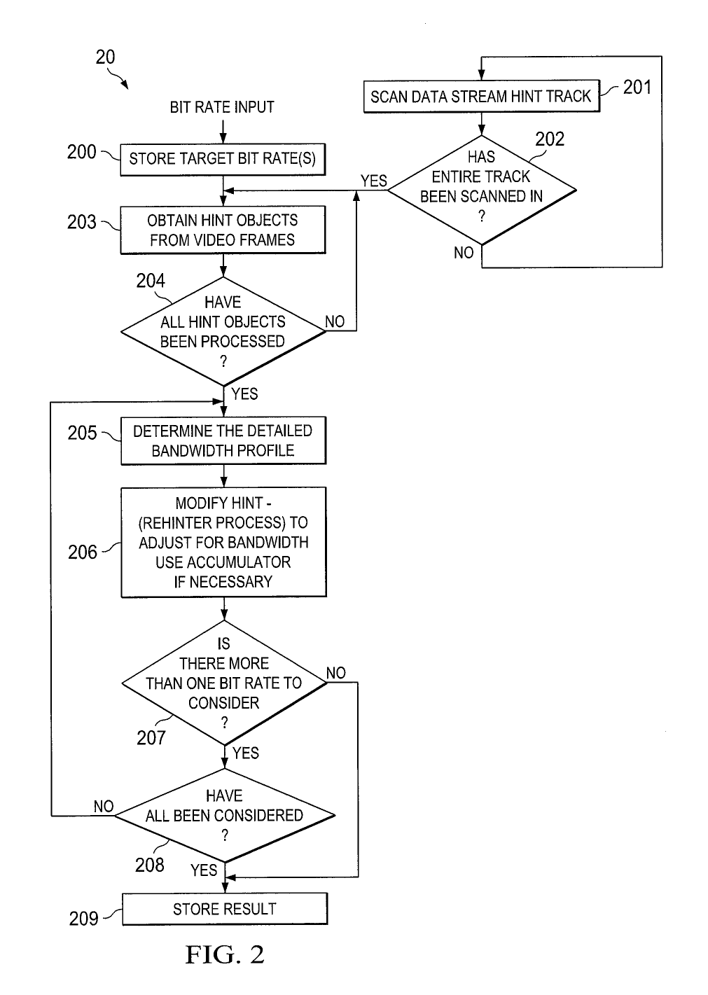

FIG. 2 shows one embodiment of a process, such as process 20, for achieving proper rehinting. Rehinting being defined as a timing adjustment to the normal hinting arrangement in a video data stream. As will be discussed, in this embodiment, the process consists of looking at the video sequence from the last frame back to the first. For each frame, the amount of data required and the maximum bandwidth is taken into account. The length of time required to send that frame's data is calculated and then a determination is made as to when the frame must start sending to complete before the viewing time of that frame. This is repeated going backward through the video while carrying over from frame to frame any starting offset.

There are a number of considerations pertaining to the size (height and width) of the peaks and valleys, their distribution throughout the video and the number of consecutive peaks or valleys. These must be considered in addition to the process discussed and are dependant upon such factors as, density of frames, number of scene changes, encoding algorithm and options, the types of frames used (e.g., predictive or bi-predictive frames), and the distance between intra-coded frames. The amount of data sent early will determine the size of the buffer required (or available) at the user's location, as well as the up-front delay before the start of video playback.

Process 200 stores the target bitrate, which defines the maximum transmission rate desired on the network. This rate typically can vary widely, from a few hundred kilo bits per second (kbps) to several mega bits per second (Mbps). Since this is network dependant this range should normally remain constant over long periods of time. However, in some situations, the rate could be changed for delivery over different networks and in one embodiment more than one rehinting timing could be stored so that the movie (or other rehinted video file) can be advantageously transmitted over networks having different transmission characteristics. In this manner, the transmission timing can be tailored for specific networks and a “one timing for all” approach need not be used. To accomplish this, process 200 can pre-store different bitrates for different networks and can also have an input for receiving a desirable bitrate on a case by case basis.

Process 201 scans the original hint track for the video stream, using a subset of the information contained within the hint track to construct the data structure discussed with respect to FIG. 1. Process 202 determines if the entire hint track has been scanned. Typically, the entire file will be scanned, however, in some situations it might be desirable to only scan portions of the video file at a time.

Process 203 walks backwards over the linked list of hint objects, modifying the send time of individual packets in order to smooth out the bandwidth profile to lie within the target bitrate. As discussed above, the target bitrate can be the same for all rehinted files or it can be different depending on various factors, including the anticipated network to be used for transmission and/or the location of the remotely located end-user or decompressor.

In one embodiment, the modification is accomplished by finding the existing ‘rtp_’ hint track in the MPEG4 file which corresponds to the desired video file. Once the hint track is located, a new hint track object is allocated (block 101, FIG. 1). The binary representation of the hints are parsed by reading the number of hint samples in the track. For each hint sample in the hint track, the following steps are performed:

1) Allocate a new hint object (block 102, FIG. 1);

2) Fill in the offset value which acts as the base for the packet object (block 104) offset values for each packet in this video frame;

3) Initialize the block 102 data size value to zero;

4) Read the number of packets used to send this frame of video; and

5) For each packet in this frame, perform the following steps:
A) Allocate a new packet object (block 104);
B) Fill in the block 104 offset value so that the send time value can be found in this packet for later modification, if desired;
C) Initialize the block 104 size value to zero;
D) Read the number of individual chunks which will be sent in this packet; and
E) For each chunk, perform the following steps:
   i) According to the standardized types of chunk defined in the hint track standard, decide whether this chunk will result in bytes of data being sent out over the network;
   ii) if so, calculate how many bytes will be sent;
   iii) add that value to the block 104 size accumulator for this packet;
   iv) also add that value to the block 102 data size accumulator for this video frame; and
   v) iterate for each hint sample object.

After all hint objects have been processed, as determined by process 204, process 205 determines the bandwidth profile by first saving the block 101 clock values by copying the MPEG4 timescale value from the input file. The block 101 frame value is also saved by dividing the MPEG4 duration value from the file by the number of hint objects processed, so as to calculate the number of clock ticks per frame. This process serves to construct the data structure of FIG. 1.

Process 205 now has enough information to determine the detailed bandwidth profile of this file as originally created by the MPEG4 hinter. Once the bandwidth profile is created by the unmodified hinter, the system can examine it and modify it as needed to spread out transmission peaks over a longer time period to reduce the maximum bandwidth peaks.

Process 206 then modifies the hint track by reviewing each hint object in reverse order. This is necessary if it is desired to have the end of every frame transmission arrive on time to the remote location decoder. Arriving early just means that a buffer is necessary. However, arriving late affects viewing quality. Rehinting rearranges the instantaneous data rates of a data file to fit within the bandwidth limitations of the network (or in some embodiments dependant upon the remote location or the identity of the decompressor) by moving certain object start times ahead by enough time so that the entire video frame can be sent at the specified network data rate with a high degree of confidence that the file will arrive in time to be decoded and displayed with high fidelity. The bandwidth requirements of various remote locations or identities can, for example, be stored at the rehinter and the bitrate can then be used to adjust the forward movement of the timing of certain objects to accommodate the bandwidth requirements of the network.

Because some frames may be very large, they may take several frame times to send if the network bandwidth limitations are small. A start time accumulator is used and is designed to persist among video frames. This allows a large frame to push ahead the start time for a group of preceding video frames until a run of small size (low data rate) frames is found which can absorb the extra data to be subsequently transmitted.

One example of a process for rehinter modification is as follows:

Given a target bitrate, initialize the start time accumulator to zero. For each hint in reverse order, perform the following steps:

1. Calculate the number of bits to be sent using block 102 data size;

2. Using the input target bitrate and block 101 clock, calculate the number of clock ticks required to send this frame, plus any outstanding unsent data from previously processed (i.e., later in time) frames which did not fit into their timeslots and were therefore left in the start time accumulator;

3. If the ticks required to send all current and outstanding data is less than one frame time, then set the start accumulator to zero, otherwise set it to one frame time minus the number of ticks required to send all current and outstanding data. In other words, add the current data load to the accumulator, then reduce the accumulator by the maximum amount of data that can be sent in the current time slot;

4. If all the data can be sent in this timeslot, zero the accumulator; otherwise, carry the difference over to the next hint (i.e., move it to the timeslot of the previous frame in time);

5. Once the updated start time is in the accumulator, process each packet in the current hint. The hinter sets the send time for each packet to the start of the frame time, resulting in a bandwidth spike at the start of each frame. The start time of each video frame is tweaked using the accumulator calculated above, plus the send time of each packet is also tweaked so they aren't all bunched up at the start of the frame time; and

6. Initialize a bytes sent counter to zero.

For each packet in the current frame, perform the following steps:

A. Using the input target bitrate and the start time accumulator and the bytes sent accumulator, calculate the send time of this current packet;

B. Using block 102 offset and time, modify the send time of this individual packet in the original hint track;

C. Add block 104 size to the bytes sent counter so that it will delay the rest of the packets in this block 104 packet list by the amount of time it took to send block 104 size bytes at the input target bitrate.

Optionally, processes 207 and 208 determine if there are more than one bitrates to rehint for. If not, then the rehinted video files are stored ready for delivery over a bandwidth limited network.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for transmitting video files across a bandwidth limited network, said method comprising:
obtaining certain data, from an existing hint track of a received video file, one such;
determining data sizes and object send times from obtained objects using said obtained hint track data; and
modifying certain of said obtained object send times to reduce network bandwidth constraints on subsequent transmission of said video file.

2. The method of claim 1 wherein said modifying comprises:
moving send times of objects having high data rates forward in time to take advantage of send times of objects having relatively low data rates, said moving reducing data delivery delays from a present location of said video file to a remotely located decompressor.

3. The method of claim 2 wherein said high data rate is calculated relative to a selected network bandwidth bitrate.

4. The method of claim 2 wherein said high data rate is calculated relative to a location of a remotely located decompressor.

5. The method of claim 2 wherein said modifying further comprises:
reviewing object data size in reverse order from the end of video file to the front.

6. The method of claim 2 further comprising:
spreading start times of an object over several objects by accumulating excess time from object to object.

7. A system comprising:
a processor for modifying a hint track of a video file, each said video file containing a hint track including send times of objects within said video file, said send times modified under control of said processor such that objects having a data size sufficiently high to exceed bandwidth constraints of said network are moved forward in time and sent in conjunction with objects having a low enough data size to accommodate at least a portion of said advanced objects without causing delays due to said bandwidth; and
a memory for storing therein at least portions of modified video files prior to transmission to a remote location over a bandwidth limited network.

8. The system of claim 7 wherein said modifying comprises:
determining from time to time a value for determining a sufficiently high threshold based on a selected network bandwidth bitrate.

9. The system of claim 7 wherein said modifying comprises:
means for determining from time to time a value for determining a sufficiently high threshold based on a location of a remotely located decompressor.

10. The system of claim 7 wherein said modifying further comprises:
means for reviewing object data size in reverse order from the trailing end of a video file to the front end.

11. The system of claim 7 wherein said modifying further comprises:
means for spreading start times of an object over several objects by accumulating excess time from object to object.

12. A method for increasing the confidence that a video file will arrive at a destination over a bandwidth limited transmission network, said method comprising:
scanning said data file to obtain hint objects from a hint track of said data file;
determine a bandwidth profile of at least a portion of said data file; and
modifying said hint track by adjusting start times of certain objects in order to smooth out bandwidth consistent with said transmission network bandwidth limitations.

13. The method of claim 12 wherein adjusted start times comprises moving said certain object's start time forward consistent with start times of objects having bandwidth requirements lower than said transmission network can accommodate.

14. The method of claim 13 wherein said bandwidth profile is determined, at least in part, by reviewing said objects from the end of said file portion to the beginning of said file portion.

15. The method of claim 13 wherein said moving comprises:
utilizing start times of more than one object ahead of said start time moved object.

16. The method of claim 13 further comprising:
determining transmission bandwidth limitations from time to time; and
adjusting start times for a particular file based upon a determined bandwidth limitation.

17. The method of claim 16 wherein said determining occurs for each transmission.

18. The method of claim 16 wherein said determining is based on an identity of a decompressor of said file at a remote location of said transmission.

19. The method of claim 16 wherein said determining is based on a location of a decompressor of said file at a remote location of said transmission.
